(19) United States
(12) Patent Application Publication
(10) Pub. No.: US 2008/0224536 A1
(43) Pub. Date: Sep. 18, 2008

(54) Transmission Line Structure for Power Line Communication and Power Line Switch Used Therein

(75) Inventor: Shohei YAMAZAKI, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 12/045,953

(22) Filed: Mar. 11, 2008

(30) Foreign Application Priority Data
Mar. 13, 2007 (JP) 2007-062862

(51) Int. Cl. H04B 3/54; H04B 3/56

(52) U.S. Cl. 307/1

(57) ABSTRACT

A power line switch apparatus is provided for use in a power line communication system that transmits a signal through a power line that feeds a power supply current. In the power line switch apparatus, a switch section is inserted in the power line to make or break connection of the power line. A power line filter is connected in series to the switch section and inserted in the power line, the power line filter being used to pass the power supply current and to cut off the signal of the power line communication system. A by-pass circuit is connected in parallel with the series connection of the switch section and the power line filter, the by-pass circuit including a by-pass filter for cutting off the power supply current and passing the signal of the power line communication system.

### BACKGROUND OF THE INVENTION

1. Field of the Invention

The present invention relates to a transmission line structure for smooth PLC: Power Line Communication via a distribution board and/or a circuit breaker, and to a power line switch used in the transmission line structure for the power line communication.

2. Background Art

Now, power line communication for performing digital communication by means of power line wirings distributed across the country is going to be put to practical use. This power line communication mainly applies to short-distance communication networks using indoor or local area wiring or ‘last mile’ connection wiring rather than to long-distance telecommunication using high-voltage transmission line (Non-patent document 1).

Non-patent document 1: “Report”, online, December, 2005, Society concerning the high-speed electric power line transportation communication, searched on Feb. 23, 2007, Internet URL: http://www.soumu.go.jp/s-news/2005/pdf/051226_{—}6_bt2.pdf.

It is likely that, unlike the high-voltage transmission line, the indoor and local area wirings, however, are not suitable for communication due to the structure of their wirings, which may have switches including a circuit breaker midstream and/or wiring branches.

This means that, any switch including a circuit breaker situated in the wiring causes power line communication signals (PLC signals) to be transmitted with the switch on, while it causes the PLC signals to be cut off as the power supply is shut off with the switch off. Also there is a problem where any branch in the power line causes extreme variation in high-frequency impedance at a branch point, which results in the degradation of transmission of PLC signals. There are further problems, including in security, due to the same PLC signals being transmitted to the entire branches, as well as problems of convergence, that is likely caused due to reduction of the capacity of transmittable communication data because of the transmission of the same signal to the entire branches.

### SUMMARY OF THE INVENTION

It is an object of the present invention to provide a transmission line structure for power line communication, capable of smoothly performing power line communication even using a power line having a switch and/or a branch, and to provide a power line switch used for the transmission line structure for power line communication.

In accordance with a first aspect of the present invention, a transmission line structure is provided for use in a power line communication system that transmits a signal through a power line that feeds a power supply current, the transmission line structure comprising: a switch section that is inserted in the power line to make or break connection of the power line; and a by-pass circuit that is connected in parallel with the switch section and that is equipped with a by-pass filter for cutting off the power supply current and passing the signal of the power line communication system.

In accordance with a second aspect of the present invention, a transmission line structure is provided for use in a power line communication system that transmits a signal through a power line that feeds a power supply current, the transmission line structure comprising: a switch section that is inserted in the power line to make or break connection of the power line; a power line filter that is connected in series to the switch section and inserted in the power line, the power line filter being used to pass the power supply current and cut off the signal of the power line communication system; and a by-pass circuit that is connected in parallel with the series connection of the switch section and the power line filter, the by-pass circuit comprising a by-pass filter for cutting off the power supply current and passing the signal of the power line communication system.

In accordance with a third aspect of the present invention, the by-pass circuit further includes a signal selection section for selecting whether to pass or cut off the signal of the power line communication system according to contents of the signal inputted to the by-pass circuit.

In accordance with a fourth aspect of the present invention, a transmission line structure is provided for use in a power line communication system that transmits a signal through a power line that feeds a power supply current, the power line having an upstream line of a power supply side and downstream lines of load sides that are branched from the upstream line of the power supply side, the transmission line structure comprising: a power line filter that is inserted into each downstream line of the load side and that is used to pass the power supply current and to shut off the signal of the power line communication system; and a branch by-pass circuit that is connected in parallel to each of the power line filter and that has a by-pass filter connected between the power supply side and each of the load sides, the by-pass filter being used to shut off the power supply current and to pass the signal of the power line communication system.

In accordance with a fifth aspect of the present invention, the transmission line structure further comprises a switch section that is inserted in each of the downstream lines of the load sides in series with the power line filter, and that is connected in parallel with the branch by-pass circuit, and that is used to make or break each of the downstream lines of the load sides.

In accordance with a sixth aspect of the present invention, the transmission line structure further comprises a signal selection section that is included in the branch by-pass circuit, and that is used to re-transmit to one or more of the downstream lines, the signal of the power line communication system inputted from the upstream line of the power supply side according to contents of the signal.

In accordance with a seventh aspect of the present invention, a power line switch apparatus is provided for use in a power line communication system that transmits a signal through a power line that feeds a power supply current, the power line switch apparatus comprising: a switch section that is inserted in the power line to make or break connection of the power line; and a by-pass circuit that is connected in parallel with the switch section and that is equipped with a by-pass filter for cutting off the power supply current and passing the signal of the power line communication system.

In accordance with an eighth aspect of the present invention, a power line switch apparatus is provided for use in a power line communication system that transmits a signal through a power line that feeds a power supply current, the power line switch apparatus comprising: a switch section that is inserted in the power line to make or break connection of the power line; a power line filter that is connected in series to the switch section and inserted in the power line, the power line filter being used to pass the power supply current and cut off the signal of the power line communication system; and a by-pass circuit that is connected in parallel with the series connection of the switch section and the power line filter, the by-pass circuit comprising a by-pass filter for cutting off the power supply current and passing the signal of the power line communication system.

In accordance with a ninth aspect of the present invention, the by-pass circuit further includes a signal selection section for selecting whether to pass or cut off the signal of the power line communication system according to contents of the signal inputted to the by-pass circuit.

According to the present invention, providing the by-pass circuit in the switch section for making/breaking a power line can pass a power line communication signal (PLC signal) via the by-pass circuit even with the power line shut off when breaking the switch section, thereby maintaining the power line communication even with the power supply shut off.

According to the present invention, by also providing the power line filter in series to the switch section, a PLC signal can always pass via the by-pass circuit, thereby allowing a PLC signal to be transmitted all time under the same conditions regardless of the on/off status of the switch section.

Further according to the present invention, providing the by-pass circuit and further providing the signal selection section in the by-pass circuit can select or sort a PLC signal according to the content thereof, thereby preventing unwanted transmission of information to ensure and maintain security and reducing convergence in communication.

### BRIEF DESCRIPTION OF THE DRAWINGS

FIGS. 1(A) and 1(B) are block diagrams showing the configuration of a circuit breaker, which constitutes a first embodiment of the present invention.

FIGS. 2(A) and 2(B) are block diagrams showing the configuration of a circuit breaker, which constitutes a second embodiment of the present invention.

FIG. 3 is a block diagram showing the configuration of a distribution board, which constitutes a third embodiment of the present invention.

FIG. 4 is a block diagram showing the configuration of a branch by-pass circuit, which constitutes the third embodiment of the present invention.

### DESCRIPTION OF THE PREFERRED EMBODIMENTS

Referring to the drawings, the configuration of a circuit breaker is described, which constitutes a first embodiment of the present invention. This circuit breaker is configured so as to pass a PLC (power line communication) signal from the primary side to the secondary side and vice versa, regardless of the make/break status of a contact.

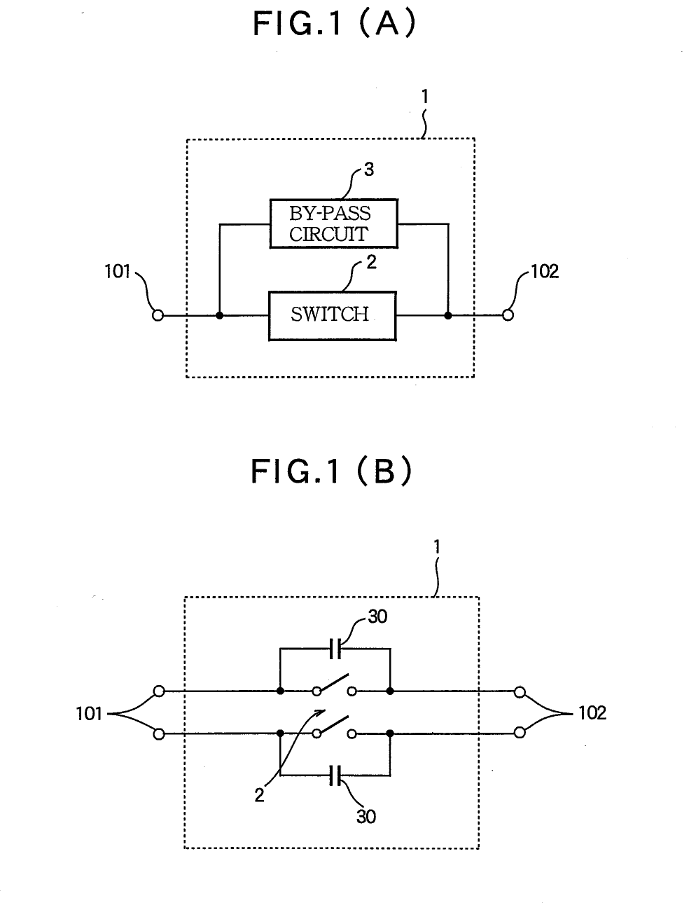

FIG. 1 shows the configuration of a circuit breaker, which constitutes a first embodiment of the present invention. Shown in (A) of the same figure is the block diagram showing the function of each part. The circuit-breaker 1 has a primary side terminal 101 connecting to the primary side (power supply side) and a secondary side terminal 102 connecting to the secondary side (load side) of the power line. The circuit breaker has a switch 2 and a by-pass circuit 3 that are connected in parallel between the primary side terminal 101 and the secondary side terminal 102. The switch 2 normally makes electrical connection between the primary side terminal 101 and the secondary side terminal 102. It cuts off (disconnects) the connection when the supply current exceeds the rated current value (20A, for example).

PLC (power line communication) signals have a frequency range of 2 to 30 MHz, for example, while the power supply current frequency is 50 Hz or 60 Hz in Japan, for example. The by-pass circuit 3 includes a filter for cutting off the current of the power supply frequency and passing a PLC signal.

With the contact of the switch 2 closed, both the power supply current and a PLC signal pass through the switch 2. With the contact of the switch 2 open, power supply current is cut off while a PLC signal passes through the by-pass circuit 3 from the primary side to the secondary side or vice versa.

The diagram (B) of the same figure exemplifies a practical circuit construction of the circuit breaker shown in the diagram (A) of the same figure. It is shown in the diagram that the contact of the switch 2 is open, that is, the connection between the primary side and the secondary side of the line power is normally disconnected. As to a circuit breaker, however, the contact of the switch 2 is normally closed, that is, the connection between the primary side and the secondary side of the power line is normally connected. When secondary side current exceeds the rated value, the switch 2 breaks its contact to disconnect the primary side from the secondary side of the power line. An electromagnetic solenoid not shown makes the disconnection.

In the diagram (B) of the same figure, a capacitor 30 constitutes the by-pass circuit 3. The capacitor 30 has such amount of capacitance as to cut off the current of a power supply frequency of 50 Hz or 60 Hz and pass a PLC signal, as described above.

In the diagram (B) of the same figure, a bipolar switch is used for the switch 2. However, a single-pole switch may be used with one side (HOT side) of the power line connected.

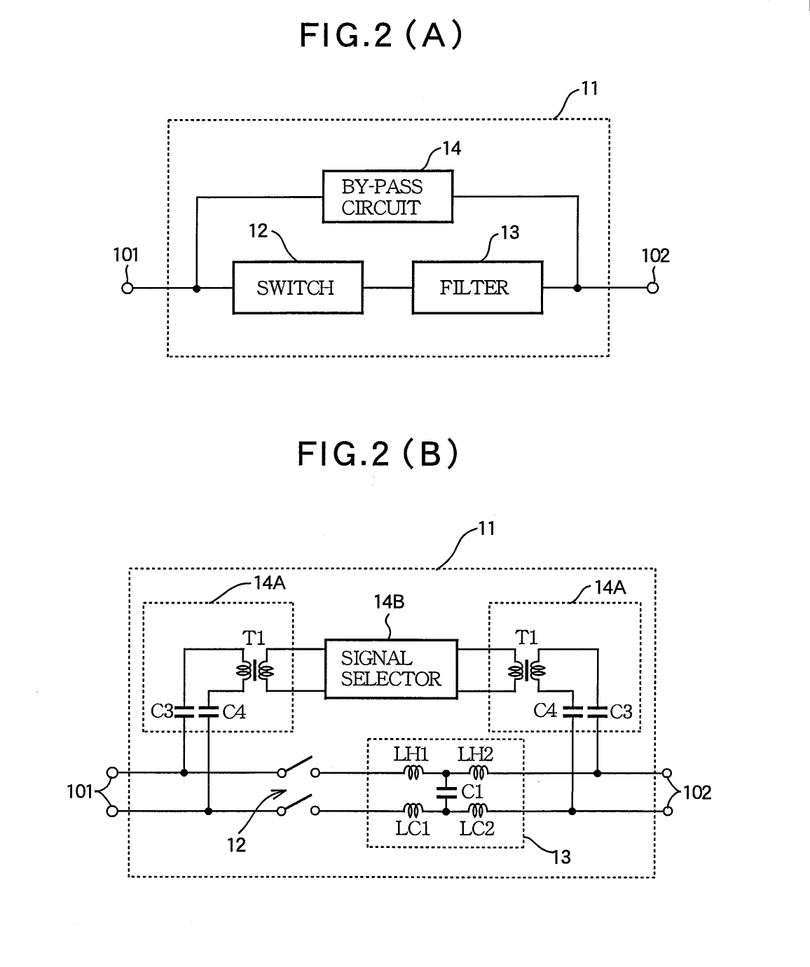

An embodiment in FIG. 1 is described, exemplifying a general overcurrent breaker used as a power line switch. The power line switch is, however, not limited to an overcurrent breaker, and may use various devices including a leakage breaker and a manual switch (a covered switch, for example), etc. Such embodiment of the present invention is not limited to the integration of a switch and a by-pass circuit. An embodiment as shown in FIG. 1 and FIG. 2 may include a switch and a by-pass circuit that are constituted as an independent component part, respectively, and electrically connected to each other.

FIG. 2 shows the configuration of a circuit breaker, which constitutes a second embodiment of the present invention. The diagram (A) of the same figure is the block diagram showing the function of each part; while the diagram (B) is the diagram showing an example circuit structure of the circuit breaker.

The circuit breaker 11 includes a primary terminal 101 connected to the primary side (power supply side) and a secondary terminal 102 connected to the secondary side (load side) of the power line. A switch 12 and a power line filter 13 are connected in series between the primary side terminal 101 and the secondary side terminal 102. And a by-pass circuit 14 is connected in parallel with the switch 12 and the power line filter 13 connected in series.

The switch 12 normally makes electrical connection between the primary side terminal 101 and the secondary side terminal 102. It cuts off (disconnects) the connection when the secondary side current exceeds the rated current value (20A, for example).

The power line filter 13 is used to pass the current of a power supply frequency of 50 Hz or 60 Hz, for example and cut off a PLC signal of a frequency range of 2 to 30 MHz. It includes: two high frequency choke coils LC1 and LC2 connected in series and inserted on the HOT side of the power line; two high frequency choke coils LC1 and LC2 connected in series and inserted on the COLD side of the power line; and a by-pass capacitor C1 which is connected between the connection between the two high frequency choke coils LAC and LAD on the HOT side and the two high frequency choke coils LC1 and LC2 on the COLD side. Due to this configuration, the power line filter 13 constitutes a low-pass filter LPF. The power line filter 13 has such a cut-off characteristic as to cut off a signal of a frequency not less than 2 MHz and pass a signal of a frequency not greater than this.

The by-pass circuit 14 is composed of a signal selection section 14B and a by-pass filter 14A provided for both the primary side terminal and the secondary side terminal of the signal selection section 14B. The by-pass filter 14A includes a capacitor C3 connected to the HOT side of the power line, a capacitor C4 connected to the COLD side of the power line, and a high frequency transformer T1. The power line side terminal and the terminal opposite to it of the capacitors C3 and C4 are connected to either terminals, respectively, on the primary side of the high frequency transformer T1. The secondary side of the high frequency transformer T1 is connected to the signal selection section 14B.

The capacitors C3 and C4 each have such capacitance as to cut off the current of power supply frequency of 50 Hz or 60 Hz and pass a PLC signal of a frequency range of 2 to 30 MHz. This allows a PLC signal superimposed on the power line or a PLC signal output from the signal selection section 14B to pass through such capacitors, and prevents power supply current fed by the power line from transmitted to the high frequency transformer T1.

The high frequency transformer T1 is used to mediate the input/output of a PLC signal to/from the signal selection section 14B and insulate the signal selection section 14B from power supply voltage (electric potential). This means that, an electric potential value vary on the primary side of the high frequency transformer T1 due to the electrostatic coupling of the capacitors C3 and C4 with the power line, however, this electrical potential variations are not transmitted to the secondary side. And the high frequency transformer T1 transmits a PLC signal of a frequency range of 2 to 30 MHz from the primary side to the secondary side and vice versa, due to electromagnetic coupling.

The signal selection section 14B judges whether or not a PLC signal (packet) input from the primary side (terminal 101 side) of the power line is addressed to a device connected to the secondary side (terminal 102 side) of the power line. It outputs the signal to the secondary side, if judged that the signal is addressed to a device connected to the secondary side; while it cuts off or discards the signal, if judged otherwise. This means that, it cuts off the signal when it treats the signal in the form of a sequential high frequency signal level; while it discards the signal (packet) when it treats the signal in the form of a digital data level such as packets. The signal selection section 14B also judges whether or not a PLC signal input from the secondary side of the power line is addressed to a device connected to the primary side of the power line. It outputs the signal to the primary side, if judged that the signal is addressed to a device connected to the primary side; while it cuts off or discards the signal, if judged otherwise.

PLC signal has no limitations in protocol, however, the selection of a signal described above may be performed based on the header information at the layer 2 (Data Link Layer) or layer 3 (Network Layer) of the OSI reference model. This means that, the signal selection section 14B has packet selection function as incorporated in the devices such as bridge or router.

Therefore, a PLC signal (packet) transmitted through the power line is input to the signal selection section 14B of the by-pass circuit 14 in the breaker 11 without passing through the switch 12. The signal selection section 14B judges whether or not to pass the packet based on the information of the packet including destination address. This reduces the convergence of a PLC signal on the power line and minimizes the risk of unwanted exposure of the information in a packet to a third party that may exist due to the unconditional transmission of the packet.

An embodiment in FIG. 2 may not require a signal selection section 14B. That is, the by-pass circuit 14 may be constituted only by a by-pass filter that cuts off power supply current while passes a PLC signal only. Since this configuration also makes it possible to pass a PLC signal regardless of the making/breaking status of the switch 12, the communication state can be stabilized compared to the embodiment of FIG. 1.

An embodiment in FIG. 2 is described, exemplifying a general overcurrent breaker used as a power line switch. The power line switch is, however, not limited to a overcurrent breaker, and may use various devices including a leakage breaker and a manual switch (a covered switch, for example), etc. Such embodiment of the present invention is not limited to the integration of a switch, a filter and a by-pass circuit. An embodiment as shown in FIG. 2 may include a switch, a filter and a by-pass circuit that are constituted as an independent component part, respectively, and electrically connected to one another.

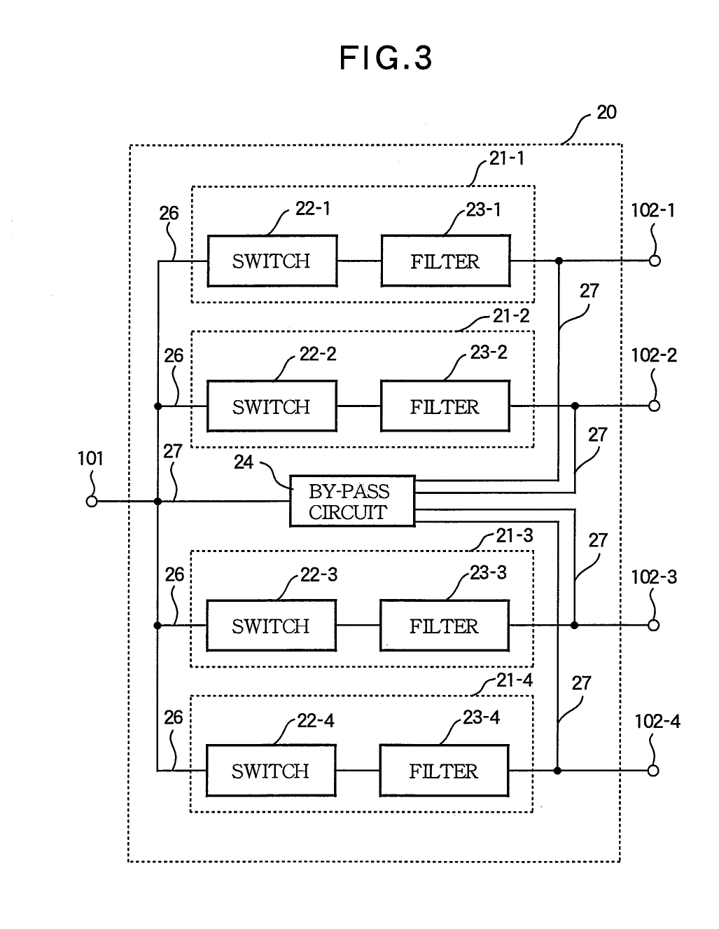

FIG. 3 is the block diagram showing a transmission path structure for power line communication, which constitutes a third embodiment of the present invention. This diagram shows the configuration of a circuit of a distribution board 20. In the distribution board 20, power supply is branched into four downstream power lines, and each of circuit breakers 21-1˜4 is inserted in each of the branched power lines, respectively.

A power line wiring 26 connected to a primary side (power supply side) terminal 101 of the distribution board 20 is branched into four downstream lines, each of which is connected to each of secondary side (load side) terminals 102-1˜4 via each of the circuit breakers 21-1˜4, respectively.

Each circuit breaker 21 includes a switch 22 and a power line filter 23. Since this configuration is similar to that of the switch 12 and the power line filter 13 in the embodiment in FIG. 2, the detailed information is omitted. Thus a PLC signal does not pass through the circuit breaker 21 in this distribution board 20.

On the other hand, a signal line wiring 27, which differs from the power line wiring 26, is provided between the primary side terminal 101 and the secondary side terminals 102-1˜4 on the four branched power lines of the distribution board 20. The signal line wiring 27 connects a branch by-pass circuit 24 to the primary side terminal 101 and connects the by-pass circuit 24 to the secondary side terminals 102-1˜4.

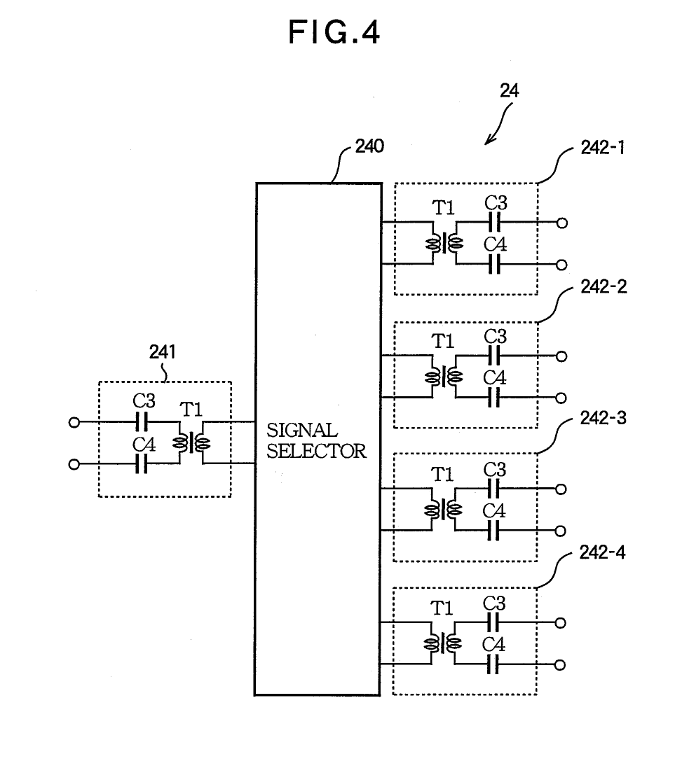

FIG. 4 shows the detailed configuration of a branch by-pass circuit 24. The branch by-pass circuit 24 includes: a by-pass filter 241 for cutting off the current of a power supply frequency on a primary side terminal 101 and passing a PLC signal; by-pass filters 242-1˜4 for cutting off the current of a power supply frequency on secondary side terminals 102-1˜4 and passing a PLC signal; and a signal selection section 240 for switching a PLC signal (packet) input from the five by-pass filters 241 and 242-1˜4 and outputting them to their target terminals (by-pass filter), respectively.

Since the configuration of the respective by-pass filters 241 and 242-1˜4 is similar to that of the filter 14A in the embodiment shown in FIG. 2, the detailed information is omitted.

The signal selection section 240 switches packets based on the header information at layer 2 (Data Link Layer) or layer 3 (Network Layer) of the OSI reference model. This means that, the signal selection section 240 has packet selection function as incorporated in the devices such as switching hub, layer-2 switch or multi-port router.

Due to the configuration above, in the distribution board 20, the power supply from the upstream line is branched into four downstream lines, PLC signals (packets) from one line on the power supply side and four lines on the load side are switched with each other and retransmitted to the destination device of the respective packets. Thus because the input packets are retransmitted only to the destination power line, it is possible to reduce the convergence of PLC signals on the respective power lines and minimize the risk of unwanted exposure of the information in the packets to a third party due to unconditional transmission.

An embodiment in FIG. 3 is described, exemplifying a distribution board. If the power line is branched with any device other than a distribution board used, it is possible to switch packets using the branch by-pass circuit 24. In such a case, the respective branch lines require the filter 23 but not the switch 22.

The branch by-pass circuit 24 of the embodiment in FIG. 3 described above uses the signal selection section 240 for switching the input packets and outputting them to the destination line only. The embodiment may include a waveform correction circuit and an amplifier in stead of the signal selection section 240 so that a packet input from a certain line is output to the all the other lines. That is, it may have the function of a repeater hub.

In the embodiment in FIG. 3 described above, four branch lines are provided, however, the number of the branched lines provided is not limited to four. In the embodiment described above, packet switching is performed by a single branch by-pass circuit 24, however, this may be performed by a plurality of branch by-pass circuits if a large number of branched lines are provided.

1. A transmission line structure for use in a power line communication system that transmits a signal through a power line that feeds a power supply current, the transmission line structure comprising:
a switch section that is inserted in the power line to make or break connection of the power line; and
a by-pass circuit that is connected in parallel with the switch section and that is equipped with a by-pass filter for cutting off the power supply current and passing the signal of the power line communication system.

2. A transmission line structure for use in a power line communication system that transmits a signal through a power line that feeds a power supply current, the transmission line structure comprising:
a switch section that is inserted in the power line to make or break connection of the power line;
a power line filter that is connected in series to the switch section and inserted in the power line, the power line filter being used to pass the power supply current and cut off the signal of the power line communication system; and
a by-pass circuit that is connected in parallel with the series connection of the switch section and the power line filter, the by-pass circuit comprising a by-pass filter for cutting off the power supply current and passing the signal of the power line communication system.

3. The transmission line structure according to claim 2, wherein the by-pass circuit further includes a signal selection section for selecting whether to pass or cut off the signal of the power line communication system according to contents of the signal inputted to the by-pass circuit.

4. A transmission line structure for use in a power line communication system that transmits a signal through a power line that feeds a power supply current, the power line having an upstream line of a power supply side and downstream lines of load sides that are branched from the upstream line of the power supply side, the transmission line structure comprising:
a power line filter that is inserted into each downstream line of the load side and that is used to pass the power supply current and to shut off the signal of the power line communication system; and
a branch by-pass circuit that is connected in parallel to each of the power line filter and that has a by-pass filter connected between the power supply side and each of the load sides, the by-pass filter being used to shut off the power supply current and to pass the signal of the power line communication system.

5. The transmission line structure according to claim 4, further comprising a switch section that is inserted in each of the downstream lines of the load sides in series with the power line filter, and that is connected in parallel with the branch by-pass circuit, and that is used to make or break each of the downstream lines of the load sides.

6. The transmission line structure according to claim 4, further comprising a signal selection section that is included in the branch by-pass circuit, and that is used to re-transmit to one or more of the downstream lines, the signal of the power line communication system inputted from the upstream line of the power supply side according to contents of the signal.

7. A power line switch apparatus for use in a power line communication system that transmits a signal through a power line that feeds a power supply current, the power line switch apparatus comprising:
a switch section that is inserted in the power line to make or break connection of the power line; and
a by-pass circuit that is connected in parallel with the switch section and that is equipped with a by-pass filter for cutting off the power supply current and passing the signal of the power line communication system.

8. A power line switch apparatus for use in a power line communication system that transmits a signal through a power line that feeds a power supply current, the power line switch apparatus comprising:
a switch section that is inserted in the power line to make or break connection of the power line;
a power line filter that is connected in series to the switch section and inserted in the power line, the power line filter being used to pass the power supply current and cut off the signal of the power line communication system; and
a by-pass circuit that is connected in parallel with the series connection of the switch section and the power line filter, the by-pass circuit comprising a by-pass filter for cutting off the power supply current and passing the signal of the power line communication system.

9. The power line switch apparatus according to claim 8, wherein the by-pass circuit further includes a signal selection section for selecting whether to pass or cut off the signal of the power line communication system according to contents of the signal inputted to the by-pass circuit.
